(19) United States
(12) Patent Application Publication
(10) Pub. No.: US 2002/0082919 A1
(43) Pub. Date: Jun. 27, 2002

(54) System method and article of manufacture for affiliate tracking for the dissemination of promotional and marketing material via e-mail

(76) Inventors: Michael Landau, Sausalito, CA (US); Evan Horowitz, San Francisco, CA (US)

Correspondence Address: Brian R. Coleman, OPPENHEIMER WOLFF & DONNELLY LLP, P.O. Box 10356, Palo Alto, CA, 94303, US

(21) Appl. No.: 10/005,514

(22) Filed: Nov. 6, 2001

Related U.S. Application Data
(63) Continuation-in-part of application No. 09/846,159, filed on May 1, 2001.
(60) Provisional application No. 60/201,041, filed on May 1, 2000.
(60) Provisional application No. 60/246,544, filed on Nov. 6, 2000.

(51) Int. Cl. G06F 17/60; G06F 15/16

(52) U.S. Cl. 705/14; 709/203

(57) ABSTRACT

A method is provided for performance based referral credit based on user transactions utilizing a network. A referring entity is allowed to present a publication. The referring entity is assigned a unique identifier associated with the publication. Input from a user is received for subscribing to the publication utilizing a network. A tracking code is assigned that traces to the user input and the unique identifier. The publication is forwarded to the user based on the user input utilizing the network. The user is allowed to select an entity associated with the publication. The tracking code is identified when the user conducts a transaction with the entity, in order to provide a credit to the referring entity.

### CROSS REFERENCE TO RELATED APPLICATIONS

This application is a continuation-in-part of U.S. Non-Provisional Application No. 09/846,159 entitled “A System, Method, and Article of Manufacture for Internet Based Affiliate Pooling”, filed May 1, 2001 and claiming the benefit of U.S. Provisional Application No. 60/201,041, filed May 1, 2000, incorporated herein by reference. This application is also related to and claims the benefit of U.S. Provisional Application No. 60/246,544, filed Nov. 6, 2000.

### BACKGROUND OF THE INVENTION

The present invention relates generally to e-commerce and, more particularly, to systems methods and articles of manufacture for integrating dissemination of promotional and marketing material via e-mail with an Internet based affiliate system.

Presently, both merchants and consumers are increasingly conducting aspects of their commerce via a network of computers known as the Internet. Such business is commonly referred to as “e-commerce,” or “electronic commerce.”

The Internet enables vast and immediate interconnectedness through the use of a common software structure, generated and read via computer code known as hypertext markup language or “HTML.” Access to information and movement around the web is enhanced through the use of hyperlinks (“links”) within a web page's HTML. The link, manifest as a word in a text field or an image on a web page, acts as a path, moving a user from one web page address, known as a Uniform Resource Locator (URL), to another web page address.

The movement from one URL to another allows near-instant access to information, products, and services and is particularly well-suited to the exchange of information, goods, and services between buyers (“users”) and sellers (“Merchants”). Such business is commonly referred to as “e-commerce,” or “electronic commerce.”

With the abundance of goods and services available, a problem arises in efficiently connecting an interested user with the appropriate information pertaining to the desired goods and/or services. A Merchant therefore must make known, or advertise, its URL in order to reach those users on the Internet that are interested in the goods and/or services offered. Hypertext links lend themselves to an active (rather than static) advertisement since they actually provide the user with a path or entry point to the Merchant's URL. Then, once he has arrived at the Merchant's URL, the user can initiate a transaction.

By advertising through the use of hyperlinked banner images and/or text links, a Merchant may increase its sales by increasing the number of users (commonly referred to as “traffic”) that visits their URL, and potentially increase transactions.

To this end, the Merchant must determine how and where on the Internet to advertise in order to maximize traffic that fits the Merchant's targeted market. In contrast to traditional static advertising, hyperlinked advertising is active, providing a mechanism to chart a transaction from inception to end. Such transactions begin with the initial movement from advertisement to Merchant URL, and end with the completion of the user's transaction.

The ability to track every stage of a transaction allows the Merchant to see the exact origin of its traffic (i.e., from a given advertisement at a given URL). Further, this tracking mechanism allows the Merchant to determine advertising compensation based on a system which measures the quantity of traffic and/or that traffic's performance. Such a system, which relies on a tracking mechanism, is commonly referred to as an “affiliate system.”

Most Merchants currently utilize some form of affiliate system to increase sales, track traffic, and compensate webmasters for referrals of traffic and/or transactions. Webmasters are the content providers of the Internet, who maintain URLs in order to disperse information and links to other URLs. These links are often in the form of a Merchant's advertisement, such as a banner ad. Therefore, the webmaster directs traffic to given Merchants via his selection and placement of Merchant links. The webmaster is then generally compensated according to a given pay scale and/or interval, based in some way on the referred traffic.

The growing popularity of affiliate systems among both webmasters and Merchants has led to a wide array of resources addressing affiliate commerce. Such Internet resources include search engines, directories, and compilations of webmaster feedback relating exclusively to affiliate systems.

The affiliate system has become a standard and well-accepted method of on-line commerce and marketing. Commonly, a given Merchant chooses to have its own stand-alone affiliate system (cf., for example, Bezos, U.S. Pat. No. 6,029,141, as used by http://www.amazon.com) or to be part of network or community of Merchants sharing a common affiliate software or structure (cf., for example, Messer, U.S. Pat. No. 5,991,740, as used by http://www.linkshare.com). Other hybrid affiliate system models also exist (cf., for example, Landau and Horowitz, “System Method and Article of Manufacture for Internet Based Affiliate Pooling,” patent application submitted 5/1/2000, as used by http://www.xpays.com), from which a Merchant can choose.

E-mail is also a very important and popular component of the Internet. It has emerged as an effective and efficient means of communication, with myriad uses in both the personal and commercial realms (customer service and marketing, for example). One very effective use of e-mail occurs between Merchants and users on the Internet, as Merchants can easily maintain contact with customers and users who are interested in the Merchant's products or services. For example, a user, when visiting a Merchant's web site, or viewing an advertisement for a Merchant while visiting another web site, can opt to subscribe to a Merchant's “newsletter,” whereby the user will receive periodic e-mail communications from the Merchant. Such e-mails can include news and updates about products or services, special deals on current products or services, and so on. Commonly, a user submits his e-mail address through an HTML input function in order to initiate a subscription to the newsletter; commonly, a user encounters such a subscription form either when purchasing a product or service from the given Merchant or when viewing an advertisement for that Merchant on the web.

An e-mail newsletter can contain content provided by a Merchant or some third party, along with various hyperlinked images and/or text links within the e-mail message. By advertising its products or services through the use of hyperlinked images and/or text links within an e-mail newsletter, a Merchant may increase its sales by increasing the traffic that visits its URL, and potentially increase transactions.

Prior to the present invention, an affiliate program would integrate e-mail marketing into its system by compensating its affiliate webmasters based on a flat fee per confirmed e-mail address (i.e., per user who submits his valid e-mail address and confirms his subscription). Some form of confirmation is required in order to prevent fraudulent or unwanted subscriptions and to verify that the user's e-mail address is not abused. The affiliate system and/or Merchant define the method of confirmation before accepting e-mail addresses and crediting affiliate webmasters for referred e-mail addresses. Typically, a referring affiliate webmaster would be paid anywhere from $0.25 to $0.75 per confirmed e-mail address, depending on the terms of the respective affiliate system.

Periodic newsletters are then transmitted via e-mail to the Merchant's and/or affiliate system's list of subscribers, in order to communicate information and promote products and/or services to these subscribers and thus increase transactions for those Merchants whose hyperlinked advertisements are included in each newsletter.

A user is also able to unsubscribe to any given newsletter, commonly by resubmitting his e-mail address to the subscription system, or by clicking a special “unsubscribe” hyperlink within a previously received e-mail newsletter. An unsubscribed user will then be removed from the list of subscribers and will not receive further e-mail newsletters, therefore eliminating future informational or marketing contact by the Merchant to that user's e-mail address.

Several shortcomings become evident in regard to the methods of integrating e-mail marketing and affiliate systems prior to the present invention. First, prior methods do not allow the affiliate webmaster (the referring source of the e-mail subscribers) to share in the actual value of his referred subscribers. Because the Merchant and/or affiliate system has already assigned a flat commission rate on a “per confirmed e-mail” basis, the affiliate webmaster is paid for the quantity of referred subscribers rather than the quality of referred subscribers. Here, quality refers to the measure of actions taken by the subscriber as a result of the newsletter's informational and/or promotional hyperlinks which results in a transaction (and potential revenue) for the Merchant. Performance can thus be defined as the number of Merchant transactions and/or resulting revenue enabled by the targeted hyperlinks within the newsletter. When the value of a confirmed e-mail address is fixed or established without consideration of actual performance, the affiliate webmaster is compensated, in a sense, blindly.

In addition, because the actual value of a referred subscriber can not be determined before the actual performance of that subscriber can be assessed, a Merchant and/or affiliate system must expend resources in order to create, implement, and maintain some formula or set of calculations using data gleaned from previous subscriber performance. Such formulas or calculations will necessarily rely on averages and adjustments in order to arrive at a set value to compensate webmasters per referred e-mail address, thus generalizing and reducing the performance of past referred subscribers to a single value per address. The up-to-the-minute buying habits of the referred traffic and/or current market fluctuations will therefore not be considered, because the compensation per e-mail has already been determined. The Merchant and/or affiliate system must constantly analyze performance data in order to adjust the formula or set of calculations used to determine the payout rates for affiliate webmasters. This continual analysis is expensive, inefficient, and potentially inaccurate; in short, applying last week's data to today's sales leaves the Merchant at a disadvantage in determining affiliate compensation.

Also, because the prior models of integrating e-mail marketing and affiliate systems are based only on the quantity of confirmed e-mail addresses, it is the quantity that becomes the focal point of the affiliate program, rather than the actual revenue such addresses generate for the Merchant. Such models that depend upon quantity rather than performance encourage the mass or artificial manufacture of e-mail subscriptions. Prior models are therefore extremely vulnerable to fraud.

### SUMMARY OF THE INVENTION

Briefly, a preferred embodiment of the present invention is a system, method, and apparatus for providing performance based referral credit based on user transactions utilizing a network in accordance with the present invention. The network may include a wide area network and/or a local area network. A referring entity is allowed to present a publication, the referring entity being assigned a unique identifier associated with the publication. The publication may include a newsletter and/or an e-mail announcement. Input from a user is received for subscribing to the publication utilizing a network and a tracking code is assigned that traces the user input and the unique identifier. The tracking code may include the unique identifier. The user input may include an e-mail address. The publication is then forwarded to the user based on the user input utilizing the network. The user is allowed to select an entity associated with the publication, and the tracking code is identified when the user conducts a transaction with the entity in order to provide credit to the referring entity. The entity associated with the publication may be represented by a link, and advertisement, contact information, an input button, a script, and/or a drop down menu. Further, compensation may be provided for the credit of the referring entity. The compensation may include monetary compensation, return referrals, discounted services, and/or no-charge services.

The foregoing and other objects, features, and advantages of the invention will be apparent from the following detailed description of the preferred embodiment(s) which make(s) reference to (the several figures of) the drawing.

### BRIEF DESCRIPTION OF THE DRAWINGS

The invention, together with further advantages thereof, may best be understood by reference to the following description taken in conjunction with the accompanying drawings in which:

FIG. 1 shows an example of a typical user computer system;

FIG. 2 is an overall diagram of the system components and their interconnectedness;

FIG. 3 is a flowchart showing a method for the initial subscription, storage, and correlation processes in integrating the dissemination of promotional and marketing material via e-mail and an Internet based affiliate system, in one embodiment of the present invention;

FIG. 4 shows an example of the HTML code required to implement of the e-mail submit box—that is, for the web based input function used to execute the HTTP transfer of the user's e-mail address and the unique identifying code embedded in the referring webmaster's HTML—coded web page—in one embodiment of the present invention;

FIGS. 5A and 5B show examples of the storage and reference of submitted data in a sample database structure, where every subscribed user's e-mail address references its referring webmaster's unique identifying code, along with any further user preferences or personal data supplied by that user, in accordance with an embodiment of the present invention;

FIG. 6 is a flowchart showing a method for integrating, on a performance basis, the dissemination of marketing e-mails and affiliate tracking, in one embodiment of the present invention;

FIG. 7 shows an example of a completed e-mail newsletter template, utilizing referenced storage information, in accordance with an embodiment of the present invention; and

FIG. 8 is a flowchart illustrating a process for providing performance based referral credit based on user transactions utilizing a network in accordance with the present invention.

### DETAILED DESCRIPTION OF THE INVENTION

An invention is disclosed for integrating the dissemination of promotional and marketing material via e-mail and an Internet based affiliate system. In the following description, numerous specific details are set forth in order to provide a thorough understanding of the present invention. It will be apparent, however, to those skilled in the art, that the present invention may be practiced without some or all of these specific details in order to not unnecessarily obscure the present invention.

The following terms and acronyms are used throughout the detailed description:

Client-Server. A model of interaction in a distributed system in which a program at one site sends a request to a program at another site and waits for a response. The requesting program is called the “client,” and the program which responds to the request is called the “server.” In the context of the World Wide Web (discussed below), the client is a “web browser” (or simply “browser”) which runs on a user's computer; the program which responds to a browser request is commonly referred to as a “web server.” A user will access the World Wide Web buy using the browser program installed on their computer, e.g., Netscape® or Internet Explorer®. The browser will then request information from a server or series of servers. The server provides the information to the browser, usually in the form of a web page or web site.

Hyperlink. A navigational link from one document to another, or from one portion (or component) of a document to another. Typically, a hyperlink is displayed as a highlighted word or phrase that can be selected by clicking on it, using a mouse or other input devise. The link will then allow the user to go from one web site or web page to another, or from one portion of a page to another.

Hypertext System. A computer-based informational system in which documents (and possibly other types of data entities) are linked together via hyperlinks.

Internet. A collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

World Wide Web (“web”). Used herein to refer generally to both (i) a distributed collection of interlinked, user-viewable hypertext documents (commonly referred to as web documents or web pages) that are accessible via the Internet, and (ii) the client and server software components which provide user access to such documents using standardized Internet protocols. Currently, the primary standard protocol for allowing applications to locate and acquire web documents is HTTP, and the web pages are encoded using HTML. However, the terms “web” and “World Wide Web” are intended to encompass future markup languages and transport protocols which may be used in place of (or in addition to) HTML and HTTP.

Web Site. A computer system that serves informational content over a network using the standard protocols of the World Wide Web. Typically, a web site corresponds to a particular Internet domain name, such as “amazon.com,” and includes the content associated with a particular organization. As used herein, the term is generally intended to encompass both (i) the hardware/software server components that provide the informational content over the network, and (ii) the “back end” hardware/software components, including any non-standard or specialized components, that interact with the server components to perform services for web site users.

HTML (Hyper Text Markup Language). A standard coding convention and set of codes for attaching presentation and linking attributes to informational content within documents. (HTML 2.0 is currently the primary standard used for generating web documents.) During a document authoring stage, the HTML codes (referred to as “tags”) are embedded within the informational content of the document. When the web document (or HTML document) is subsequently transferred from a web server to a browser, the codes are interpreted by the browser and used to parse and display the document. Additionally, in specifying how the web browser is to display the document, HTML tags can be used to create links to other web documents (commonly referred to as “hyperlinks”). For more information on HTML, see Ian S. Graham, The HTML Source Book, John Wiley and Sons, Inc., 1995 (ISBN 0471-11894-4).

HTTP (Hyper Text Transport Protocol). The standard World Wide Web client-server protocol used for the exchange of information (such as HTML documents, and client requests for such documents) between a browser and a web server. HTTP includes a number of different types of messages which can be sent from the client to the server to request different types of server actions. For example, a “GET” message, which has the format GET, causes the server to return the document or file located at the specified URL.

URL (Uniform Resource Locator). A unique address which fully specifies the location of a file or other resource on the Internet. The general format of a URL is protocol://machine address:port/path/filename. The port specification is optional, and if none is entered by the user, the browser defaults to the standard port for whatever service is specified as the protocol. For example, if HTTP is specified as the protocol, the browser will use the HTTP default port of 80.

Cookies. A technology that enables a web server to retrieve information from a user's computer that reveals prior browsing activities of the user. The informational item stored on the user's computer (typically on the hard drive) is commonly referred to as a “cookie.” Many standard web browsers support the use of cookies.

PUSH Technology. An information dissemination technology used to send data to users over a network. In contrast to the World Wide Web (a “pull” technology), in which the client browser must request a web page before it is sent, PUSH protocols send the informational content to the user computer automatically, typically based on information pre-specified by the user.

A preferred embodiment of a system in accordance with the present invention is preferably practiced in the context of a personal computer such as an IBM compatible personal computer, Apple compatible personal computer, UNIX-based workstation, or any other equivalent computer system. The computer may also be a laptop computer, a desktop computer, a WINDOWS® CE® hand-held device, a PDA e.g., a PALMPILOT, and other such computer devices with the suitable functionality.

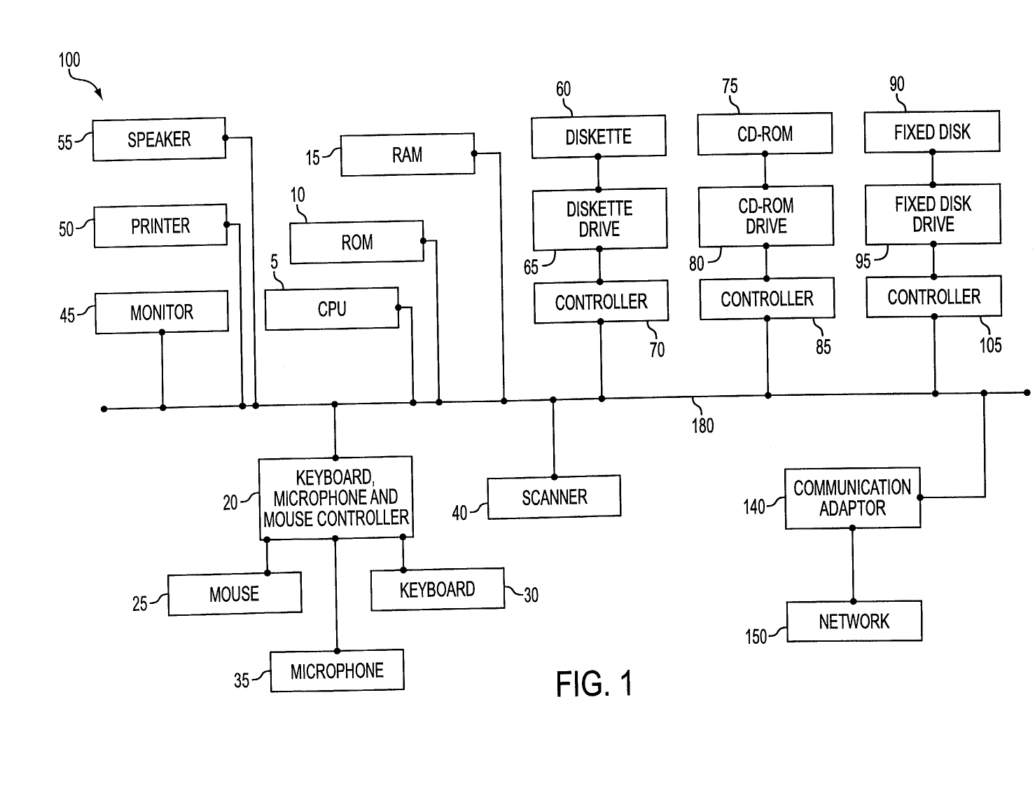

FIG. 1 depicts a typical computer system 100 having a central processing unit 5, such as a microprocessor, and a number of other units interconnected via a system bus 180 to network 150 through communication adaptor 140. Communication adaptor 140 allows the system to be interconnected to a local area network (LAN), a wide area network (WAN), or a public network.

User input to computer system 100 may be provided by a number of devices, including a keyboard 30, microphone 35 and a mouse 25 interconnected to a system bus 180 via a controller 20, and scanner 40 also interconnected to system bus 180. Computer system 100 also includes output devices, including monitor 45, speaker 55 and printer 50, each interconnected to system bus 180.

Together with central processing unit 5, computer system 100 further includes read only memory (ROM) 10, for permanent storage of information, and random access memory (RAM) 15, for temporary storage of information, each being interconnected to system bus 180. Also coupled to system bus 180, is a mass storage device which may be provided as a diskette 60. Diskette 60 is insertable into a diskette drive 65 which is, in turn, interconnected to system bus 180 by controller 70. Similarly, compact disc (CD) ROM 75 is insertable into a CD ROM drive 80 which is, in turn, interconnected to system bus 180 via controller 85. A hard disk 90 is also normally provided as part of a fixed disk drive 95 which is also interconnected to system bus 180 by controller 105.

Operation of the computer system 100 is generally controlled and coordinated by operating system software. Typically, the operating system can be any one of a number of systems including a version of the UNIX operating system, MICROSOFT WINDOWS NT, MICROSOFT WINDOWS 95, MICROSOFT WINDOWS 98, MICROSOFT WINDOWS 2000, MICROSOFT WINDOWS XP, MICROSOFT DOS, OS/2, or a version of MACINTOSH OS.

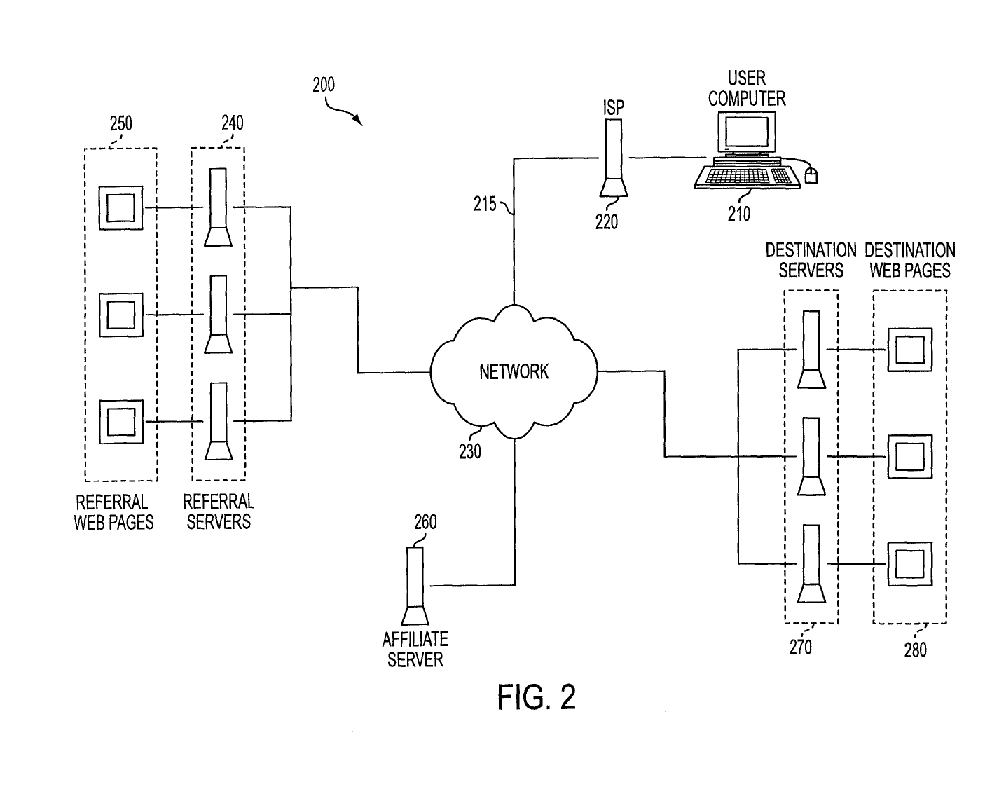

FIG. 2 illustrates the components of the system network architecture 200 in accordance with a preferred embodiment. User computer 210 is connected to network 230 through a transmission line 215, e.g. a telephone line, T-1 line or any other suitable transmission line, via an Internet Service Provider 220. The user arrives at a referring web page 250, illustrated on the user's display monitor (not shown), via the network 230 through referral servers 240. Once at the referring web page 250, the user chooses to subscribe to a newsletter and therefore provides information, including his e-mail address, to the referring web page 250. This information, together with the unique identifying code representing the referring webmaster, is then sent to the affiliate server 260, where the information is stored in correlation with the identifying code. Alternatively, upon choosing to subscribe, the user is immediately sent to the affiliate server 260, where the user information is gathered, stored, and correlated together with the identifying code. Once the information is gathered, a tracking code is generated by the affiliate server 260. The tracking code references the user's e-mail address and its associated information, including the referring webmaster's unique identifying code.

At a predetermined time interval-typically a day, week, or month—the affiliate server 260 generates a newsletter or e-mail, containing links embedded with the tracking code, linked to destination web pages 280, and sends it to the subscribing user's computer 210 via network 230. Upon receiving the newsletter or e-mail, the user can then visit destination web pages 280, via the links within the newsletter/e-mail, which are connected to network 230 through destination servers 270. Once there, the user can accept an offer of goods or services, thereby completing a transaction. After processing, a record of the transaction is then sent back to affiliate server 260 where it is correlated with the information associated with the tracking code used to track the transaction.

The owner of the affiliate server can then generate a report and pay out the owners of the referral web pages 250 in accordance with the agreement between the owners of the destination pages 280. Typically, this is done on a monthly basis. Alternatively, the affiliate server 260 can automatically generate a report and send it, together with compensation, to referral servers 240, where it is stored.

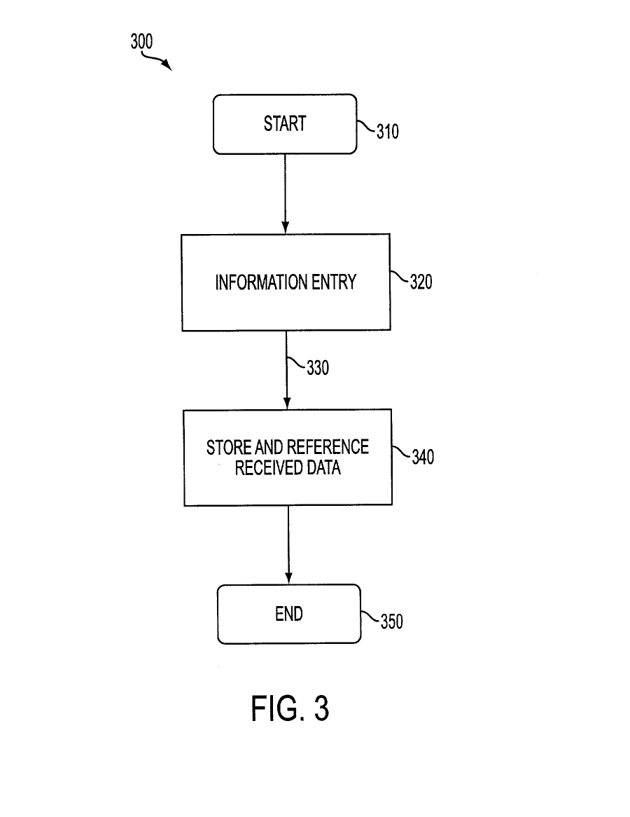

FIG. 3 is a flowchart showing method 300 for the initial subscription, storage, and correlation processes in one embodiment of the present invention. In an initial operation 310, pre-process operations are performed. Pre-process operations involve a Merchant affiliated webmaster, with a web page where that webmaster posts hyperlinked text, image links, banner ads, or other web based input functions encoded with that webmaster's unique identifying code, along with other pre-process operations that will be apparent to those skilled in the art.

In an information entry operation 320, a user visits a web page. Within the web page there exists a means of submitting information from a web browser to a given server, where the submitted data will be stored. Preferred implementation for the present invention utilizes the functionality of the HTML programming language, whereby users view and interact with web pages. In the code for the web page, an HTML form and submit mechanism grabs the information (in the present invention, an e-mail address) a user enters into an input box, and transfers 330 that information to a server upon clicking the web page's submit button. In addition, such a web based input function allows the web page itself to automatically transmit additional pieces of information, which are embedded in the HTML form and are transmitted to the server along with the e-mail address submitted by the subscribing user. The difference between these two types of information transmitted to the server, i.e. user-entered information and automatically generated information, should be noted: the user information (e-mail address) is controlled and input by the user; the generated information (in the present invention, an affiliate webmaster's unique identifying code) is embedded in the HTML code, such that the information is transmitted automatically, without manipulation by the user.

In the embodiment of the present invention, a user on the Internet arrives at a web page that is equipped with a means of submitting information from the user's web browser to a given server. The user then opts to subscribe to a Merchant's newsletter, whereby he will receive periodic e-mail communications from the Merchant, which can include news and updates about its products or services, special deals on current products or services, and so on, and inputs his e-mail address into the HTML form. The information may be submitted via a template (HTML form) or any other means that would allow the user to submit the information. The user then submits the form for processing, initiating the transfer 330 of the user's input information (user's e-mail address) and the automatically generated information (referring affiliate webmaster's unique identifying code) via HTTP, to a server for storage. The information can be submitted to either the server of the webmaster, the server of a Merchant, or a separate server, e.g. a server run by the affiliate system operator.

In a storage/reference operation 340, the user's e-mail address and the referring affiliate webmaster's unique identifying code are received by a server and stored in a database structure, in such a way that each e-mail address references its referring affiliate webmaster's unique identifying code.

It should also be noted that the Merchant can solicit other pieces of information from the user in the subscription step 320. For example, in addition to inputting his e-mail address, a user may be given certain other preferential settings from which to choose or to specify, whereby that user inputs other information that can later be used to personalize or customize the content, advertising, and subscription preferences of the newsletter. The referenced storage step 340 can also be broadened in this way; rather than passing in and storing only e-mail address and affiliate code, any other data input by the user in initiating the subscription (including any number of user preference or settings) can be stored and correlated to that subscribed e-mail address.

In operation 350, post-process operations are performed. Post-process operations can include the organization and retrieval of the information in accordance with certain parameters. For example, the e-mail addresses and corresponding data that have been referred by a particular affiliate may be retrieved. Alternatively, the e-mail addresses and corresponding data attributed to a particular preference can be retrieved and assembled. The post-process operations can also include the actual assembly of the outgoing e-mail newsletter using information retrieved from the database. Post-process operations will be apparent to those skilled in the art.

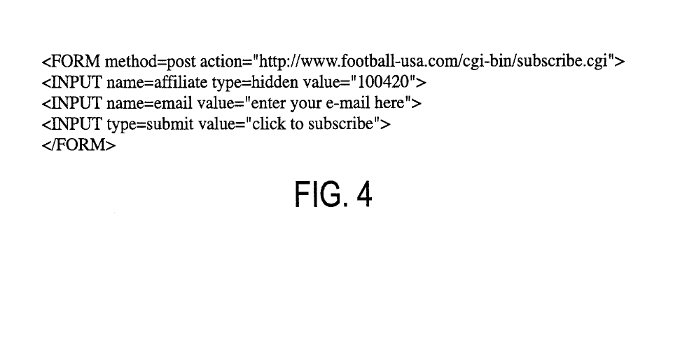

FIG. 4 shows an example of the functional HTML code required to implement the e-mail input and submit box (block 320, FIG. 3). This HTML code is used to executing the HTTP transfer of the user's e-mail address and the unique identifying code embedded in the referring webmaster's HTML-coded web page.

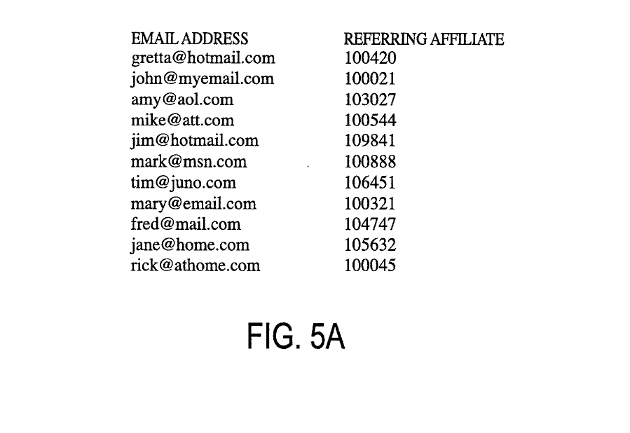

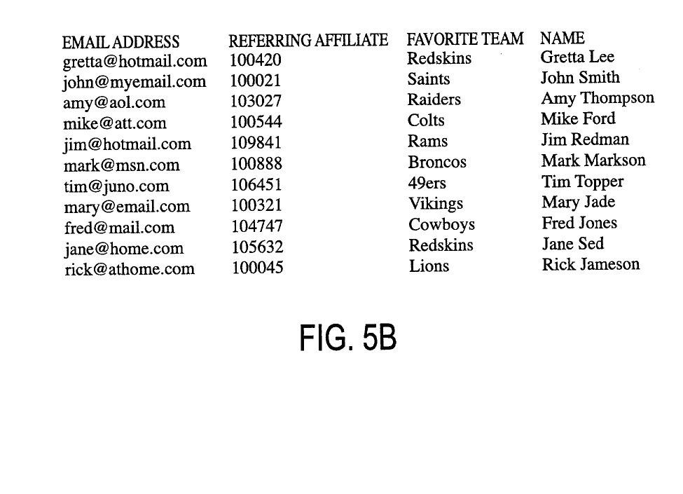

FIG. 5A shows an example of the storage and reference of the above operation in a sample database structure (as referenced previously in block 340, FIG. 3), where every subscribed user's e-mail address references its referring webmaster's unique identifying code.

FIG. 5B shows another example of the storage and reference of the above operation in a sample database structure (as referenced previously in block 340, FIG. 3), where every subscribed user's e-mail address references its referring webmaster's unique identifying code, along with other user-supplied information, such as preferences or personalization data, to be used in creating the e-mail newsletter for that subscriber.

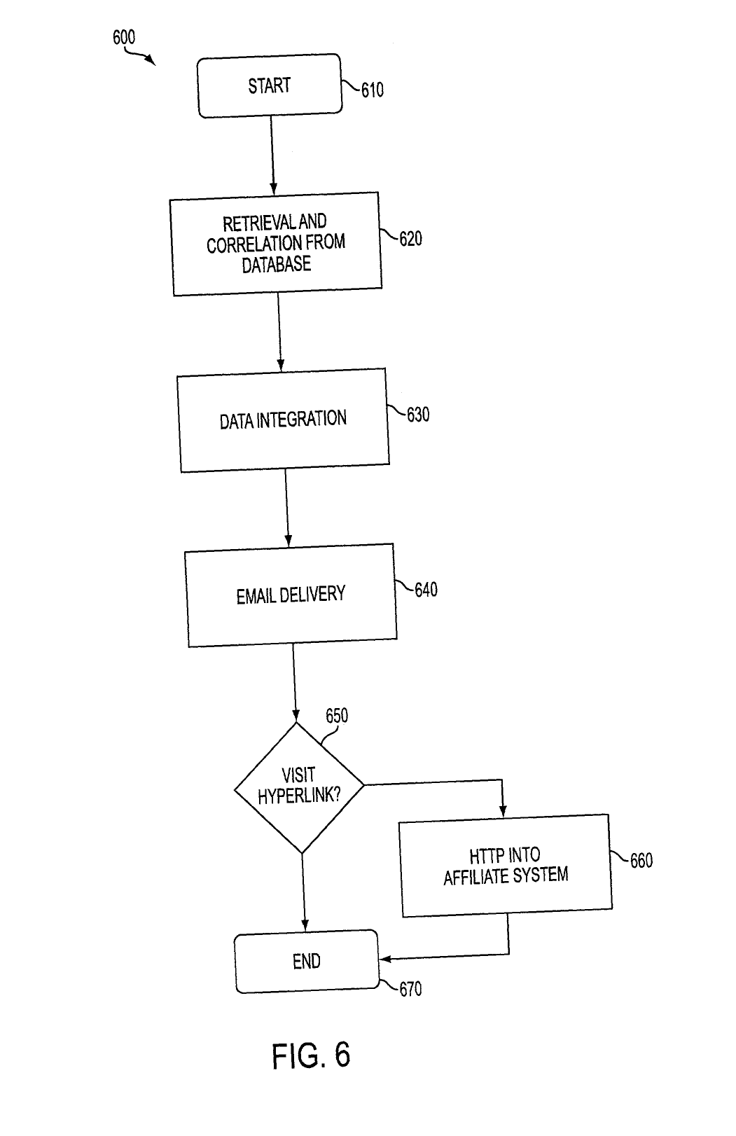

FIG. 6 is a flowchart showing method 600 for integrating a performance based tracking system with the dissemination of marketing e-mails. In an initial operation 610 pre-process operations are performed. Pre-process operations include the creation of a generalized template for the e-mail newsletter, which will be used to send the e-mail to a given list of subscribers, and the means to send the finalized e-mail from a home server to a subscriber's e-mail address, as well as other pre-process operations that will be apparent to those skilled in the art. The generalized template normally includes numerous hyperlinks, usually in the form of banner ads or text links, that direct the user to Merchant web sites or web pages.

In a retrieval/correlation operation 620, a subscriber's unique e-mail address is retrieved from a database storage structure, along with any other data stored in that database which is referenced by the subscriber's e-mail address. While the other data will always include the referring webmaster's unique identifying code, it can also include any other data input by the user and/or requested by the Merchant newsletter subscription service (for instance, preference settings or other personal information).

After the correlated data is retrieved, a tracking code corresponding to that data is created, in operation 620. The tracking code is typically the same as the webmaster's unique identifying code, but it can also be an alternate code or a combination of codes. For example, the tracking code can be the user's e-mail address or an e-mail reference code that is unique to the user's e-mail address. The tracking code could also be a number or sequence that identifies the correlated data. This tracking code would correspond to the referring webmaster's unique identifying code, the user's e-mail address, and any other correlated data. Alternatively, the tracking code could be a combination of the webmaster's unique identifying code and an e-mail reference code. The creation of the tracking code will depend upon the needs of the Merchant and/or the affiliate system administering the newsletter, using the present invention.

In a data integration operation 630, the subscriber's e-mail address, the tracking code, and any other preference, personal, or account information that is retrieved from the database in the previous operation 620, is combined with the e-mail newsletter template. The tracking code is inserted within the template in order to enable proper HTTP transfer and affiliate tracking when the subscriber clicks the hyperlinks. The subscriber's e-mail address will then be utilized as the e-mail's destination. Once the data is inserted into the template, the e-mail message is complete and ready to be sent to the subscriber.

Typically, the e-mail template will include generalized information and content commonly associated with the subject matter of the newsletter. Subscriber preferences which are retrieved in operation 620 can also be utilized in the data integration operation 630 in order to add customized or personalized content, or personalized promotional and marketing hyperlinks (either in addition to, or instead of, the generalized copy of the current newsletter template). For example, if a subscriber identifies the Redskins as being his favorite football team, the e-mail newsletter could then be customized to include more hyperlinks to Merchants who deal in Redskins paraphernalia. In fact, any number of rules can be applied to a subscriber's retrieved data, such that the content and advertising within the e-mail is determined by that user's retrieved preferences.

In an e-mail delivery operation 640, the completed newsletter template is sent via e-mail to its destination subscriber, who will receive the newsletter message upon first subsequent check of their e-mail account.

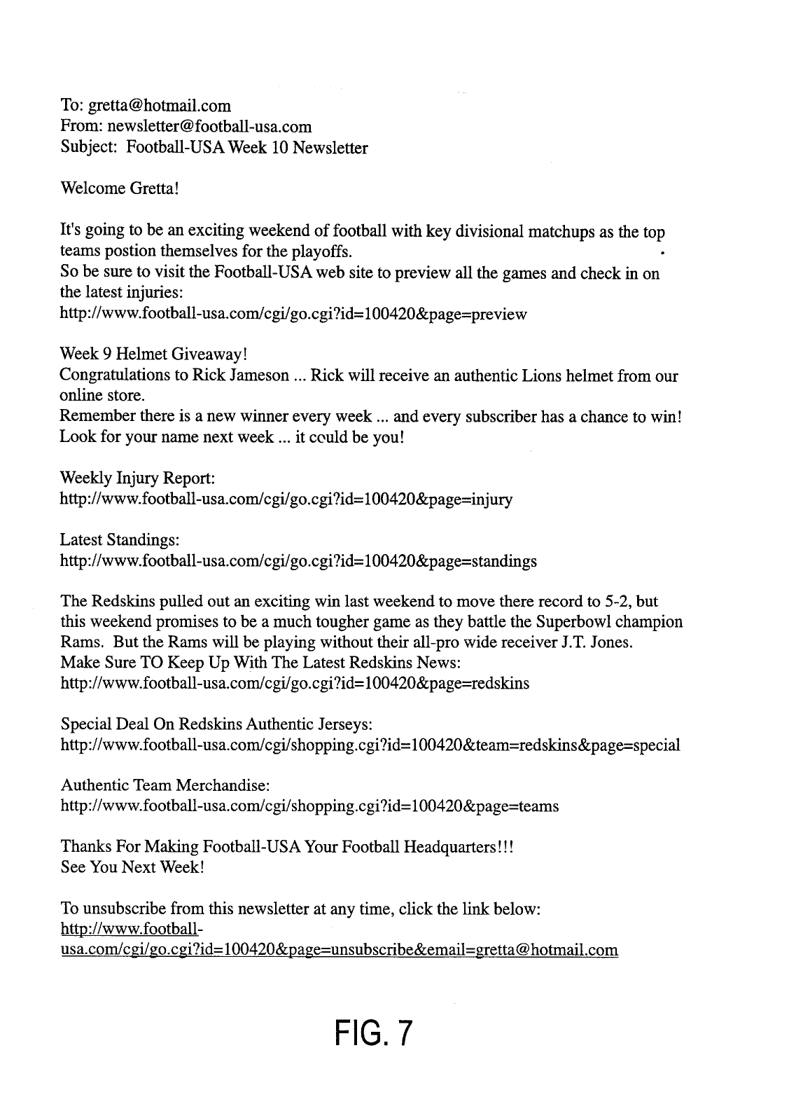

FIG. 7 shows an example of a completed e-mail newsletter template, utilizing the referenced storage information as noted in the data integration operation 630 above. In the example, the tracking code is identical to the referring webmaster's unique identifying code.

Upon receipt of the newsletter, the subscriber then decides, in operation 650, whether to initiate a visit to the Merchant using one of the promotional or marketing hyperlinks within the body of the e-mail message. This can be accomplished by either clicking on the text hyperlink or by inserting the hyperlink URL into an Internet browser application. If the subscriber initiates a visit to the Merchant, the method continues with a hyperlink transfer 660 into the appropriate affiliate system. If the subscriber does not click one of the promotional or marketing hyperlinks within the newsletter, the method continues with a final operation 670.

In a HTTP hyperlink transfer 660, the subscriber, after initiating a visit to the Merchant through one of the promotional or marketing hyperlinks within the newsletter, is taken to the appropriate URL within the Merchant's affiliate system. Once there, the subscriber can then browse the Merchant site for information, products, or services, and can initiate transactions to purchase the same.

When the HTTP hyperlink transfer is executed and the subscriber arrives at the advertised URL, the subscriber is within the affiliate system structure of the Merchant web site, as enabled by the tracking code embedded into the promotional hyperlinks within the newsletter. In this way, the e-mail newsletter's link's are an entry point, or front door, into the Merchant's website where any and all resulting transactions are tracked for referral credit by the Merchant's affiliate system. A means of adequately tracking transactions using a tracking code is the main mechanism of the affiliate system model, described extensively in prior art and general commerce on the Internet.

A “transaction,” or means by which a user must accept an offer of goods or services, is defined by the terms and conditions of the participating affiliate systems. For example, transactions can include referred purchases of products or services, referred contest entries, or simply referred visits to a particular web page. Similarly, the terms of compensation are dependent upon the agreements between the affiliate webmaster and the administrating affiliate system. Most often, compensation is based on a pre-determined interval and scale for all referred transactions. In a preferred embodiment of the present invention, the Merchant affiliate program pays its affiliate webmasters based on a percentage of sales initiated by referred subscribers of the Merchant's newsletter, who move to the Merchant web site through the advertised hyperlinks within the newsletter e-mail.

The following is an exemplary use of the embodiment of the present invention. In the following example Essociate is a company implementing the present invention, that is further capable of installing a system utilizing the present invention on Merchant servers.

Football-USA.com has a Merchant affiliate system for the promotion of its goods and services, namely providing football news and information, as well as selling athletic equipment, NFL team paraphernalia, and sports memorabilia.

Football-USA.com also offers users a free newsletter, to which users can subscribe via the Football-USA.com main web site, or via e-mail input forms within Football-USA.com advertisements on various other web sites, namely the web sites operated by Football-USA.com's affiliate webmasters.

Football-USA.com's affiliate program currently pays webmasters $0.25 per confirmed e-mail subscription.

Football-USA.com's newsletter contains news and information pertaining to football, including current events, team updates and roster moves, injury reports, and off-the-field gossip. Subscribers can also set their newsletter preferences; for example by selecting their favorite football team during the subscription process, Football-USA.com will send that subscriber a newsletter with information and news pertaining to that team. Also included in every newsletter is a promotional slogan and product/service description, followed by a hyperlink that takes the user to the Football-USA.com advertised product/service.

Football-USA.com has encountered some of the problems discussed above (Background of the Invention) and comes to Essociate looking for ways to integrate e-mail marketing into their affiliate program.

An agreement is made between Football-USA.com and Essociate, such that Essociate will enable Football-USA.com's affiliate webmasters to be compensated based on the performance of their referred e-mail subscribers, performance being measured by resulting product/service sales for Football-USA.com.

As part of the agreement, the parties define a performance based commission structure, such that, for every purchase of a product or service by a referred e-mail subscriber, the referring affiliate webmaster will receive 20% of the sale (before shipping charges or tax), paid monthly by Football-USA.com's affiliate program.

Webmaster Fred runs a site about his favorite football team, the Washington Redskins, at http://www.fredlovesfootball.com.

On his site, he participates in a Merchant affiliate system for Football-USA.com. As a participant, he places on his web site, an advertisement for Football-USA.com with an embedded newsletter subscription input form, by which users who visit his site can subscribe their e-mail address to a newsletter about their favorite team. This e-mail submit form contains Fred's unique identifying code, 100420, for the Football-USA.com affiliate program.

User Gretta is interested in football. After searching the web for her favorite team, the Washington Redskins, Gretta comes upon Fred's website at http://www.fredlovesfootball.com. After reading Fred's commentary on last week's game, Gretta decides she would like receive news about the Redskins in her e-mail.

Fred's site provides a subscription input box for Football-USA.com's weekly football newsletter. Gretta types her e-mail address into the input box and submits it. She is then taken to a screen where she can set her newsletter preferences by selecting her favorite team and confirm her subscription by clicking a submit button.

As stated, the e-mail subscription box on Fred's site contains Fred's unique identifying code, 100420, for the Football-USA.com affiliate system. When Gretta submits her e-mail address, Fred's unique identifying code and Gretta's e-mail address are passed to a server and then referenced in a database.

Football-USA.com's server then sends an automatic e-mail response to Gretta's e-mail address confirming her new subscription and welcoming her to the Football-USA.com newsletter. In this welcome letter, Football-USA.com informs Gretta of a current special on all footwear, and provides a hyperlink to the footwear section of Football-USA.com's site. This link contains a tracking code for the Football-USA.com affiliate program that corresponds to the information correlated with Gretta's e-mail address, including Fred's unique identifying code. If Gretta were to click on the link, browse the footwear section, and then purchase a pair of athletic shoes, Fred would get credit for the referred sale (via Football-USA.com's affiliate system) and earn 20% of the purchase. In this example, the tracking code is identical to Fred's unique identifying code.

In this example, Gretta decides NOT to click on this link, as she is not in need of any footwear.

For the next few weeks, Gretta receives a weekly e-mail from Football-USA.com with news about football and her favorite team, the Washington Redskins. Along with the news, Football-USA.com includes a promotional link for Redskins products. Of course, these links, along with any linked advertisements to Football-USA.com products or services within the newsletter, contain a tracking code for the Football-USA.com affiliate program, which in turn references Fred's unique identifying code. Fred, as the referrer of Gretta's e-mail address, will thus earn a commission on any purchases made by Gretta at any time through the Football-USA.com newsletter.

The next Football-USA.com newsletter that Gretta receives contains a link advertising a sale price for a Redskins jersey. Gretta decides she would love to purchase this product, and clicks on the link in order to arrive at the product within Football-USA.com's web site. As before, the link contains a tracking code for the Football-USA.com affiliate program, which in turn references Fred's unique identifying code. Fred, as the referrer of Gretta's e-mail address, will thus earn a commission on this purchase via Football-USA.com's affiliate program.

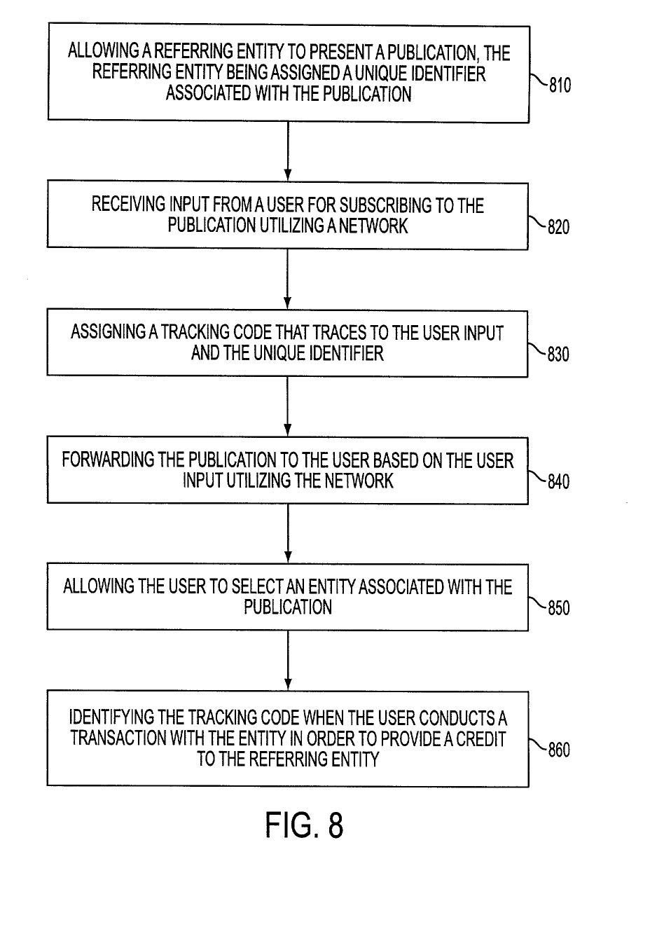

FIG. 8 is a flowchart illustrating a process for providing performance based referral credit based on user transactions utilizing a network in accordance with the present invention. The network may include a wide area network and/or a local area network. A referring entity is allowed to present a publication, the referring entity being assigned a unique identifier associated with the publication 810. The publication may include a newsletter and/or an e-mail announcement. Input from a user is received for subscribing to the publication utilizing a network 820 and a tracking code is assigned that traces the user input and the unique identifier 830. The tracking code may include the unique identifier. The user input may include an email address. The publication is then forwarded to the user based on the user input utilizing the network 840. The user is allowed to select an entity associated with the publication 850, and the tracking code is identified when the user conducts a transaction with the entity in order to provide credit to the referring entity 860. The entity associated with the publication may be represented by a link, and advertisement, contact information, an input button, a script, and/or a drop down menu. Further, compensation may be provided for the credit of the referring entity. The compensation may include monetary compensation, return referrals, discounted services, and/or no-charge services.

The present invention solves the problem of existing quantity based compensation systems. The compensation for the present invention is based upon the performance of the referred email address rather than the mere address itself. Typically, the compensation is a percentage of the revenue generated through the sale of goods or services between the user of a referred e-mail address (a subscriber to an e-mail newsletter) and a given Merchant. The more the user purchases, the more the referring affiliate webmaster is compensated. Such a method therefore does away with the need to estimate the value of any given e-mail address through the use of generic formulas, since the email address' value is directly reflected in the revenue generated for the Merchant.

A webmaster and a Merchant or set of Merchants may enter into an agreement whereby the webmaster will offer visitors to his web site (“users”) a subscription to a periodic e-mail newsletter marketed for the Merchant. Upon subscribing, the user will receive periodic e-mail communications regarding news, updates, or information about Merchant products and/or services, along with any other ancillary information.

In one embodiment of the present invention, the user initiates his subscription to the e-mail newsletter by entering and submitting into a web page input box his e-mail address during his visit to the webmaster's web page. The input box and submit mechanism are web based input functions embedded in the web page's HTML code. A unique identifying code which has been previously assigned to the referring webmaster is also embedded within the HTML code comprising the input box on the web page. Along with the user's submitted email address, the referring webmaster's unique identifying code is transmitted via HTTP to the Merchant and/or to the affiliate system which administers the newsletter. The HTML code used on the webmaster's web page (which includes the input box and submit mechanism) is typically supplied to the webmaster by the Merchant through that Merchant's affiliate system.

In another embodiment of the present invention, the webmaster directs the user to a Merchant's web site through that Merchant's affiliate system, where the e-mail input box resides.

In each of the above embodiments, the e-mail input box will include the referring webmaster's unique identification code, embedded in the HTML of the form, such that when a user submits his or her e-mail address to initiate a newsletter subscription, the referring webmaster's unique identifying code will at the same time be submitted through the HTML form.

In one embodiment of the present invention, when a user initiates a subscription by submitting his e-mail address, the address and the referring webmaster's unique identifying code are transmitted to a server for storage and correlation for later use.

In a further embodiment of the present invention, when a user initiates a subscription, the user's e-mail address and the referring webmaster's unique identifying code, along with any “preferences” or personal information supplied by the user during the subscription process, are transmitted to a server for storage and correlation for later use.

Then, an e-mail template for the current newsletter is prepared with any general content to be included for all subscribers to the newsletter This newsletter contains relevant news, updates, and other information determined by the Merchant and/or by the affiliate system administering the newsletter.

In one preferred embodiment, the user's e-mail address and the referring webmaster's unique identifying code are then used to create a tracking code. This tracking code can include the actual e-mail address or an e-mail reference code that is unique to the given e-mail address. For example, the referring webmaster's identifying code could be 1234 and the reference code for the user's e-mail address could be 9876. The tracking code could then be 12349876. Alternatively, the tracking code could be a number or sequence that identifies the correlation, say 88888. This tracking code, 88888, would then represent the correlation of the referring webmaster's unique code, 1234, and the user's e-mail or e-mail reference code, 9876. This tracking code is then used throughout subsequent processes and can be used to identify both the user's e-mail address and the referring webmaster.

In another preferred embodiment, the tracking code consists of a single code, either the referring webmaster's unique identifying code or the user's e-mail reference code. For example, the tracking code could consist of only the referring webmaster's identifying code, 1234. This tracking code is then used throughout the entire process. At a later designated time, say the time a transaction is made, the identifying code, 1234, is then redirected to the database where the referring webmaster's identifying code is correlated to the user's e-mail address. This “look up” function, or correlation, may be done at any time in the process after the user has subscribed.

The time of the correlation and the preference of using a single code or combined code will depend upon the needs of the Merchant and/or the affiliate system administering the newsletter and using the present invention.

At a given interval, a subscriber's e-mail address and the tracking code (along with any other correlated information, such as “preferences” or personal data) are retrieved from the storage database for placement within the e-mail template, such that the e-mail can now be sent to the subscriber via the inserted e-mail address. The body of the newsletter contains promotional and marketing hyperlinked URLs in the correct syntax (i.e., containing the tracking code), which enables tracking and referral credit via the Merchant's affiliate system.

In one embodiment of the present invention, promotional and marketing hyperlinked URLs are inserted into the newsletter for a single Merchant's products and/or services, such that the hyperlinked URL syntax (i.e., containing the tracking code) enables tracking and referral credit via that Merchant's affiliate system.

In another embodiment of the present invention, promotional and marketing hyperlinked URLs are inserted into the newsletter for any number of Merchants' products and/or services, such that the hyperlinked URL syntax (i.e., containing the tracking code) enables tracking and referral credit via the respective Merchant's affiliate system.

In a further embodiment of the present invention, any user preferences or personal data retrieved from the storage database (along with the subscriber's e-mail address and the referring webmaster's unique identifying code) are utilized to insert personalized content into the newsletter, according to the user's specified preferences and/or personal information.

When a subscriber receives the e-mail newsletter, he or she can choose to visit one of the promotional or marketing hyperlinked URLs, typically either by clicking on the hyperlink or by inserting the URL into their browser application. The user is then transferred via HTTP to the appropriate web page within the Merchant's or set of Merchants' affiliate system, such that any transactions (e.g., purchases) initiated by the user are tracked within the affiliate system and the referring webmaster receives credit for all such transactions. The Merchant's existing e-commerce set-up and affiliate system take over at this point, by fulfilling any customer transactions, reporting data, and paying out referring affiliate webmasters, based on the performance of their referred traffic.

Advantageously, the present invention allows affiliate webmasters to refer subscribed e-mail addresses to a given Merchant or set of Merchants and be compensated by the respective affiliate program based on the true performance of their referrals. The present invention allows referrals to be tracked specifically and thoroughly, through the entire life of the referred e-mail address (i.e., for as long as that user remains a subscriber). The invention enables tracking not only of subscriptions (cf., prior art systems which register only on a “per referred e-mail address” basis), but also tracking of actual activity and value of those subscriptions

While the invention has been particularly shown and described with reference to (a) certain preferred embodiment(s), it will be understood by those skilled in the art that various alterations and modifications in form and detail may be made therein. Accordingly, it is intended that the following claims cover all such alterations and modifications as fall within the true spirit and scope of the invention.

What is claimed is:

1. A method for providing performance based referral credit based on user transactions utilizing a network comprising:
(a) allowing a referring entity to present a publication, the referring entity being assigned a unique identifier associated with the publication;
(b) receiving input from a user for subscribing to the publication utilizing a network;
(c) assigning a tracking code that traces to the user input and the unique identifier;
(d) forwarding the publication to the user based on the user input utilizing the network;
(e) allowing the user to select an entity associated with the publication; and
(f) identifying the tracking code when the user conducts a transaction with the entity in order to provide a credit to the referring entity.

2. A method as recited in claim 1, wherein the publication includes at least one of a newsletter and an e-mail announcement.

3. A method as recited in claim 1, wherein the user input includes an email address.

4. A method as recited in claim 1, wherein the entity associated with the publication is represented by at least one of a link, an advertisement, contact information, an input button, a script, and a drop down menu.

5. A method as recited in claim 1, wherein the network includes at least one of a wide area network and a local area network.

6. A method as recited in claim 1, further comprising providing compensation for the credit of the referring entity.

7. A method as recited in claim 6, wherein the compensation includes monetary compensation, return referrals, discounted services, and no-charge services.

8. A method as recited in claim 1, wherein the tracking code includes the unique identifier.

9. A system for providing performance based referral compensation comprising:
(a) a server for providing access to a publication presented by a referring entity and for receiving input from a user for subscribing to the publication;
(b) a database coupled to the server for storing a unique identifier assigned to the referring entity in association with the publication and a tracking code that traces to the user input and the unique identifier;
(c) a computing device coupled to the server for forwarding the publication to the user based on the user input and for allowing the user to select an entity associated with the publication; and
(d) an engine for identifying the tracking code when the user conducts a transaction with the entity.

10. A system as recited in claim 9, wherein the publication includes at least one of a newsletter and an email announcement.

11. A system as recited in claim 9, wherein the user input includes an email address.

12. A system as recited in claim 9, wherein the entity associated with the publication is represented by at least one of a link, an advertisement, contact information, an input button, a script, and a drop down menu.

13. A system as recited in claim 9, wherein the network includes at least one of a wide area network and a local area network.

14. A system as recited in claim 9, further comprising providing compensation for the credit of the referring entity.

15. A system as recited in claim 14, wherein the compensation includes monetary compensation, return referrals, discounted services, and no-charge services.

16. A computer program embodied on a computer readable medium for providing performance based referral credit based on user transactions comprising:
(a) a code segment that allows a referring entity to present a publication, the referring entity being assigned a unique identifier associated with the publication;
(b) a code segment that receives input from a user for subscribing to the publication utilizing a network;
(c) a code segment that assigns a tracking code that traces to the user input and the unique identifier;
(d) a code segment that forwards the publication to the user based on the user input;
(e) a code segment that allows the user to select an entity associated with the publication utilizing the network; and
(f) a code segment that identifies the tracking code when the user conducts a transaction with the entity in order to provide a credit to the referring entity.

17. A computer program as recited in claim 16, wherein the publication includes at least one of a newsletter and an email announcement.

18. A computer program as recited in claim 16, wherein the user input includes an email address.

19. A computer program as recited in claim 16, wherein the entity associated with the publication is represented by at least one of a link, an advertisement, contact information, an input button, a script, and a drop down menu.

20. A computer program as recited in claim 16, wherein the network includes at least one of a wide area network and a local area network.

21. A computer program as recited in claim 16, further comprising providing compensation for the credit of the referring entity.

22. A computer program as recited in claim 21, wherein the compensation includes monetary compensation, return referrals, discounted services, and no-charge services.

23. A computer program as recited in claim 22, wherein the tracking code includes the unique identifier.

24. An apparatus for providing performance based referral credit based on user transactions comprising:
(a) means for allowing a referring entity to present a publication, the referring entity being assigned a unique identifier associated with the publication;
(b) means for receiving input from a user for subscribing to the publication utilizing a network;
(c) means for assigning a tracking code that traces to the user input and the unique identifier;
(d) means for forwarding the publication to the user based on the user input utilizing the network;
(e) means for allowing the user to select an entity associated with the publication; and
(f) means for identifying the tracking code when the user conducts a transaction with the entity in order to provide a credit to the referring entity.

25. An apparatus as recited in claim 24, wherein the publication includes at least one of a newsletter and an email announcement.

26. An apparatus as recited in claim 24, wherein the user input includes an e-mail address.

27. An apparatus as recited in claim 24, wherein the entity associated with the publication is represented by at least one of a link, an advertisement, contact information, an input button, a script, and a drop down menu.

28. An apparatus as recited in claim 24, wherein the network includes at least one of a wide area network and a local area network.

29. An apparatus as recited in claim 24, further comprising providing compensation for the credit of the referring entity.

30. An apparatus as recited in claim 29, wherein the compensation includes monetary compensation, return referrals, discounted services, and no-charge services.

31. An apparatus as recited in claim 24, wherein the tracking code includes the unique identifier.

32. A method for providing performance based referral credit based on user transactions comprising:
(a) allowing a referring entity to present a publication utilizing a network, the referring entity being assigned a unique identifier associated with the publication;
(b) allowing a user to conduct a transaction utilizing the publication; and
(c) identifying the unique identifier when the user conducts the transaction in order to provide a credit to the referring entity for the user transaction.

33. A method as recited in claim 32, wherein the publication includes at least one of a newsletter and an e-mail announcement.

34. A method as recited in claim 32, further comprising allowing the user to subscribe to the publication.

35. A method as recited in claim 34, wherein the user subscription includes identifying information associated with the user including an email address.

36. A method as recited in claim 32, wherein the user conducts the transaction utilizing the publication via at least one of a link, an advertisement, an input button, a script, and a drop down menu.

37. A method as recited in claim 32, wherein the network includes at least one of a wide area network and a local area network.

38. A method as recited in claim 32, further comprising providing compensation for the credit of the referring entity.

39. A method as recited in claim 32, wherein the compensation includes monetary compensation, return referrals, discounted services, and no-charge services.

40. A method as recited in claim 32, wherein the unique identifier includes a tracking code.

41. A method as recited in claim 32, further comprising providing a tracking code including the unique identifier to credit the referring entity with the user transaction.

42. A method for providing performance based referral credit based on user transactions utilizing a network comprising:
(a) assigning a unique identifier to a referring entity;
(b) allowing the referring entity to present a publication utilizing a network;
(c) receiving input from a user for subscribing to the publication;
(d) assigning a tracking code that traces to the user input and the unique identifier;
(e) storing the user input, the unique identifier, and the tracking code in a database that correlates the user input and the unique identifier with the tracking code;
(f) forwarding the publication to the user based on the user input utilizing the network;
(g) allowing the user to select an entity associated with the publication;
(h) allowing the user to visit the entity associated with the publication;
(i) receiving an indication that the user conducts a transaction with the entity associated with the publication;
(j) identifying the tracking code when the user conducts the transaction with the entity in order to provide a credit to the referring entity; and
(k) providing compensation to the referring entity based on the credit.

43. A method as recited in claim 42, wherein the publication includes at least one of a newsletter and an email announcement.

44. A method as recited in claim 42, wherein the user input includes an email address.

45. A method as recited in claim 42, wherein the visits the entity associated with the publication via at least one of a link, an advertisement, an input button, a script, and a drop down menu.

46. A method as recited in claim 42, wherein the network includes at least one of a wide area network and a local area network.

47. A method as recited in claim 42, wherein the compensation includes monetary compensation, return referrals, discounted services, and no-charge services.

48. A method as recited in claim 32, wherein the tracking code includes the unique identifier.

49. A method for providing performance based referral credit based on user transactions utilizing a network comprising:
(a) receiving a unique identifier associated with a publication from an entity for whom the publication is being marketed;
(b) displaying an offer for a subscription to the publication to a user utilizing a network;
(c) receiving input from the user for subscribing to the publication;
(d) forwarding the publication to the user utilizing the network;
(e) allowing the user to conduct a transaction utilizing the publication; and
(f) receiving a credit for the transaction based on the unique identifier associated with the publication.

50. A method as recited in claim 49, wherein the offer for a subscription to the publication is displayed on a website of a referring entity.

51. A method as recited in claim 49, wherein the input from the user is transferred to the entity for whom the publication is being marketed.

52. A method as recited in claim 49, wherein the entity for whom the publication is being marketed provides links to the user for conducting the transaction with an entity associated with the link.

53. A method as recited in claim 52, wherein the entity for whom the publication is being marketed provides compensation based on the credit for the transaction.
